(19) United States
(12) Patent Application Publication
(10) Pub. No.: US 2022/0345919 A1
(43) Pub. Date: Oct. 27, 2022

(54) COMMUNICATION TERMINAL AND COMMUNICATION QUALITY PREDICTION METHOD

(71) Applicant: NIPPON TELEGRAPH AND TELEPHONE CORPORATION, Tokyo (JP)

(72) Inventors: Kahoko TAKAHASHI, Musashino-shi, Tokyo (JP); Riichi KUDO, Musashino-shi, Tokyo (JP); Takeru INOUE, Musashino-shi, Tokyo (JP); Kohei MIZUNO, Musashino-shi, Tokyo (JP)

(73) Assignee: NIPPON TELEGRAPH AND TELEPHONE CORPORATION, Tokyo (JP)

(21) Appl. No.: 17/764,218

(22) PCT Filed: Oct. 1, 2019
(86) PCT No.: PCT/JP2019/038692

§ 371 Date: Mar. 28, 2022

(51) Int. Cl. H04W 24/08; H04W 64/00; G06V 10/764; G06T 7/70

(52) U.S. Cl. CPC H04W 24/08; H04W 64/003; G06V 10/764; G06T 7/70

(57) ABSTRACT

An object is to provide a wireless terminal and a communication quality prediction method for enhancing the versatility of communication quality prediction. In the wireless terminal and the communication quality prediction method according to the present invention, objects are extracted from surrounding environment information such as a camera image collected by a surrounding environment information collection unit, the objects are classified into predetermined categories (for example, whether the extracted objects are persons or machines or whether their moving speeds are high or low), and an image is reconstructed for each category. It is possible to predict communication quality based also on, for example, operations or materials of the objects, by performing machine learning of the communication quality after reconstructing the image for each category.

### TECHNICAL FIELD

The present disclosure relates to a communication terminal and a communication quality prediction method for predicting the quality of wireless communication according to a change in a surrounding environment.

### BACKGROUND ART

When a device having a wireless communication function (a communication device) is used, communication quality may change due to a change in a surrounding environment such as movement of objects near the device, and communication quality required by services or system of the device may not be satisfied. For example, in IEEE802.11ad or 5G of cellular communication, because a high frequency in a millimeter band is used, blocking by shields between transmission and reception sides that perform wireless communication has a great influence. In wireless communication with frequencies other than millimeter waves, a change in a surrounding environment due to blocking by shields or motion of reflective objects has an influence on communication quality. Further, Doppler shift caused by the motion of the reflective objects is also known to have an influence on communication.

It is known that a prediction model can be created by machine learning in advance and communication quality can be predicted by using the prediction model (see, for example, NPL 1). When the communication quality can be predicted, it is possible to take measures against communication quality deterioration before service or a system is influenced by an environmental change.

### CITATION LIST

### Non Patent Literature

NPL 1: H. Okamoto, et al., “Machine-learning-based throughput estimation using images for mmWave communications,” inProc., IEEEVTC2017-spring, January 2017.
NPL 2: J. Redmon, A. Farhadi, “YOLOv3: An Incremental Improvement,” CoRR, 2018.
NPL 3: Shuiwang Ji, et al. “3D Convolutional Neural Networks for Human Action Recognition,” Pattern Analysis and Machine Intelligence, vol. 35, No. 1, January 2013.

### SUMMARY OF THE INVENTION

### Technical Problem

In the technology of NPL 1, a depth camera is used to predict communication quality when a wireless communication path for millimeter wave communication is blocked due to passage of objects. NPL 1 discloses a case in which an object is only a person and a motion of the person is constant. However, an influence on communication quality changes depending on an operation or material of the object. That is, the technology disclosed in NPL 1 has a problem in that it is difficult to predict the communication quality when a plurality of types of objects made of different materials or the like operate irregularly.

Thus, an object of the present invention is to provide a communication terminal and a communication quality prediction method for enhancing the versatility of communication quality prediction in order to solve the above problems.

### Means for Solving the Problem

In order to achieve the above object, in a communication terminal and a communication quality prediction method according to the present invention, the fact that an influence on communication quality changes according to operations or materials of objects near the communication terminal is taken into consideration when the communication quality is predicted.

Specifically, the communication terminal according to the present invention is a communication terminal for performing wireless communication, the communication terminal including:

a surrounding environment information collection unit configured to photograph surroundings of the communication terminal at time intervals to generate surrounding environment information; an object determination unit configured to determine recognized objects included in the surrounding environment information on a category-to-category basis to generate object state information; and
a communication quality prediction unit configured to estimate current or future communication quality from the object state information including current object state information using a communication quality model generated by performing, in advance, machine learning of a relationship between communication quality information obtained by evaluating communication quality of the wireless communication at time intervals and the object state information of all the categories.

Further, the communication quality prediction method according to the present invention includes photographing surroundings of a communication terminal configured to perform wireless communication at time intervals to generate surrounding environment information;

determining recognized objects included in the surrounding environment information on a category-to-category basis to generate object state information; and
estimating current or future communication quality from the object state information including current object state information using a communication quality model generated by performing, in advance, machine learning of a relationship between communication quality information obtained by evaluating communication quality of the wireless communication at time intervals and the object state information of all the categories.

In the communication terminal and the communication quality prediction method according to the present invention, the objects are extracted from the surrounding environment information such as a camera image collected by the surrounding environment information collection unit, the objects are classified into the predetermined categories (for example, whether the extracted objects are persons or machines or whether their moving speeds are high or low), and an image is reconstructed for each category. It is possible to predict communication quality based also on, for example, operations or materials of the objects, by using the prediction model obtained by performing machine learning of the communication quality after reconstructing the image for each category. Thus, the present invention can provide a communication terminal and a communication quality prediction method for enhancing the versatility of communication quality prediction.

The communication terminal according to the present invention further includes:

a communication quality evaluation unit configured to evaluate the communication quality of the wireless communication and generate the communication quality information together with corresponding time information, and
a prediction model generation unit configured to perform machine learning of the relationship between the object state information corresponding to the categories and the communication quality information to generate the communication quality model, wherein the surrounding environment information collection unit photographs the surroundings of the communication terminal to generate the surrounding environment information together with corresponding time information. It is possible to generate the communication quality model in the communication terminal itself.

The communication terminal according to the present invention further includes: a communication device management unit configured to measure a current position of the communication terminal, a position of a communication terminal serving as a communication partner, or positions, attitudes, motions, and other states of the communication terminal and the communication terminal serving as the communication partner to generate communication device state information, wherein the communication quality prediction unit estimates the communication quality based also on the communication device state information, using the communication quality model generated by performing machine learning based also on the communication device state information. In this case, the communication device management unit of the communication terminal according to the present invention generates the communication device state information including time information corresponding to measurement, and the prediction model generation unit performs machine learning based also on the communication device state information to generate the communication quality model. Prediction is performed based also on an operation or attitude of the communication device, so that the versatility of communication quality prediction is further enhanced.

The object determination unit of a learning device according to the present invention fills a position corresponding to each recognized object in the object state information within an image captured by the surrounding environment information collection unit with a predetermined value, and fills other positions with “0.” Further, the object determination unit determines the position within the image by using position and size information of the recognized object in the object state information. Further, the object determination unit uses a value of a speed, object score, or depth of the recognized object as the predetermined value.

A dimension of data of the object state information can be made constant, and an amount of data can be reduced.

It is preferable for the communication quality prediction method according to the present invention to further include determining the categories based on an operation or material of the object, and replacing the previous categories with the determined categories. The categories can be updated, so that the categories can be set from the outside and a new recognition unit (a new one that has not existed before) can be categorized.

The present inventions can be combined where possible.

### Effects of the Invention

The present invention can provide a communication terminal and a communication quality prediction method for enhancing the versatility of communication quality prediction.

### BRIEF DESCRIPTION OF DRAWINGS

FIG. 1 is a diagram illustrating a communication quality prediction method according to the present invention.

FIG. 2 is a diagram illustrating the communication quality prediction method according to the present invention.

FIG. 3 is a diagram illustrating an example of category setting.

FIG. 4 is a diagram illustrating an example of the category setting.

FIG. 5 is a diagram illustrating a communication terminal according to the present invention.

FIG. 6 is a diagram illustrating an example of an object determination unit of a communication terminal according to the present invention.

FIG. 7 is a diagram illustrating a method of expressing object state information.

FIG. 8 is a diagram illustrating a method of expressing the object state information. OA is an object, and each object is filled with a score. OB is a part in which there is no object, and is filled with “0.”

FIG. 9 is a diagram illustrating the communication quality prediction method according to the present invention.

FIG. 10 is a diagram illustrating effects of the communication terminal according to the present invention.

### DESCRIPTION OF EMBODIMENTS

Embodiments of the present invention will be described with reference to the accompanying drawings. The embodiments described below are examples of the present invention, and the present invention is not limited to the following embodiments. It is assumed that components having the same reference signs in the present specification and the drawings are the same components.

### Definition

Communication quality is an index relevant to the quality when at least one of communication units in a communication terminal wirelessly communicates with an external communication terminal. Examples of the index include an index relevant to quality of experience (QoE), such as received power, a received signal strength indicator (RSSI), reference signal received quality (RSRQ), a signal to noise ratio (SNR), a signal to interference noise ratio (SINR), a packet loss rate, a data rate, application quality, an index regarding an increase or decrease in these indexes, and an index obtained by combining two or more of these indexes through linear calculation.

Examples of the type of wireless communication include downlink (transmission from a base station to a mobile terminal), uplink (transmission from a mobile terminal to a base station), and sidelink (transmission from a mobile terminal to a mobile terminal).

A terminal is hardware the movement, operation, or the like of which can be controlled, the components of which can be controlled, or the communication of which can be controlled. Examples of the mobile terminal include an automobile, a large mobile vehicle, a small mobile vehicle, a mining or construction machine, a flying vehicle such as a drone, a two-wheeled vehicle, a wheelchair, and a robot.

### EMBODIMENTS

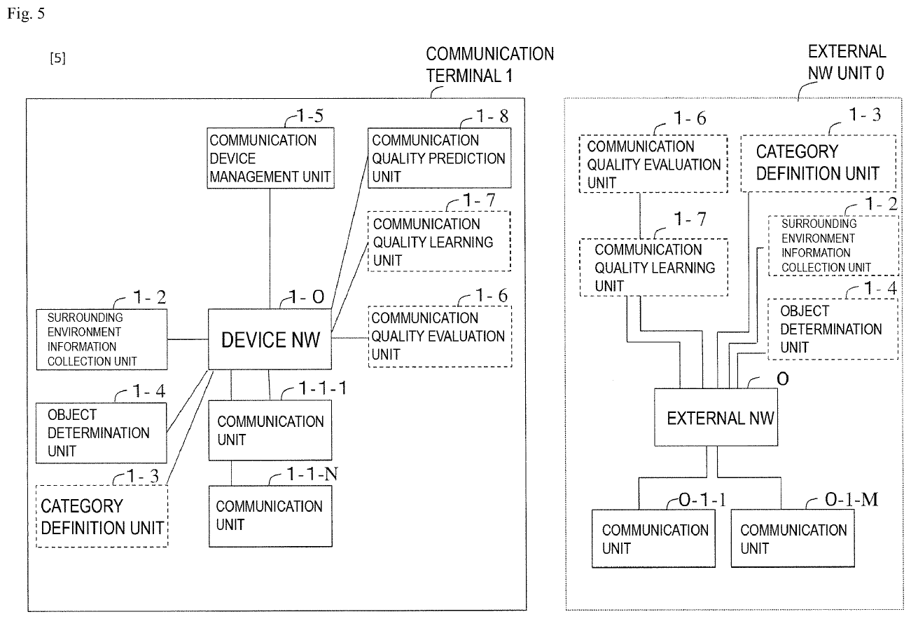

FIG. 5 is a diagram illustrating a communication system according to the present embodiment. In FIG. 5, functional units indicated by broken lines are present in either a communication terminal 1 or an external network unit 0.

The communication terminal 1 is a communication terminal that performs wireless communication, and includes

a camera (a surrounding environment information collection unit) 1-2 that photographs surroundings of the communication terminal at time intervals to generate surrounding environment information,
an object determination unit 1-4 that determines recognized objects included in the surrounding environment information on a category-to-category basis to generate object state information, and
a communication quality prediction unit 1-8 that estimates current or future communication quality from the object state information including current object state information using a communication quality model generated by performing, in advance, machine learning of a relationship between communication quality information obtained by evaluating communication quality of the wireless communication at time intervals and the object state information of all the categories.

Further, the communication terminal 1 includes

a communication quality evaluation unit 1-6 that generates communication quality information obtained by evaluating the communication quality of the wireless communication at time intervals, and
a prediction model generation unit (a communication quality learning unit) 1-7 that performs machine learning of the relationship between the object state information and the communication quality information of all the categories to generate the communication quality model.

Further, the communication terminal 1 further includes a communication device management unit 1-5 that measures a current position, attitude, motion, and other states of the communication terminal 1 to generate communication device state information.

The prediction model generation unit (the communication quality learning unit) 1-7 preferably performs machine learning based also on the communication device state information to generate the communication quality model, and the communication quality prediction unit 1-8 preferably estimates the communication quality based also on the communication device state information, using the communication quality model generated by performing machine learning based also on the communication device state information.

Hereinafter, details will be described.

The communication terminal 1 performs wireless communication with another communication terminal. Further, the communication terminal 1 can be connected to the external network unit 0 by wire or wirelessly.
The communication units (1-1-1 to 1-1-N) perform wireless communication or wired communication with the other communication terminal. Here, there are N communication units (N is a natural number), and at least one of the communication units performs the wireless communication.
The surrounding environment information collection unit 1-2 collects the surrounding environment information of the communication terminal 1 (particularly, information on moving bodies between the communication terminal 1 and the other communication terminal) using a sensor and a camera. The surrounding environment information is, for example, an image.
The object determination unit 1-4 acquires objects of each category from the surrounding environment information and the object determination model, and generates the object state information.
In a category definition unit 1-3, categories for dividing objects are set. The categories can be updated depending on situations.
The communication device management unit 1-5 generates communication device state information including at least one of a position, attitude, velocity, or acceleration of the communication terminal 1, the other communication terminal, or both.
The communication quality evaluation unit 1-6 measures the quality of wireless communication between the communication terminal 1 and the other communication terminal.
The communication quality learning unit 1-7 generates, by machine learning, a communication quality model indicating relationships between the object state information, the communication device state information, and the communication quality obtained from the functional units.
The communication quality prediction unit 1-8 uses the communication quality model to predict the current or future communication quality based also on the current or past object state information and, in some cases, the communication device state information.

The surrounding environment information collection unit 1-2, the category definition unit 1-3, the object determination unit 1-4, the communication quality evaluation unit 1-6, and the communication quality learning unit 1-7 may be included in the external network unit 0 that communicates with the communication terminal 1. When the communication quality learning unit 1-7 is included in both, for example, the communication terminal 1 may create a communication quality model from the object state information, the communication device state information, and the communication quality collected by the communication terminal 1 using the communication quality learning unit 1-7 included in the communication terminal 1. Alternatively, the communication terminal 1 can send the object state information, the communication device state information, and the communication quality collected by the communication terminal 1 to the external network unit 0, cause the communication quality learning unit 1-7 of the external network unit 0 to create the communication quality model, and receive the created communication quality model. Further, the surrounding environment information collection unit 1-2 and the object determination unit 1-4 may be included in the external network unit 0 that communicates with the communication terminal 1 or may be included in both the external network unit 0 and the communication terminal 1. When the surrounding environment information collection unit 1-2 and the object determination unit 1-4 are included in the external NW, the object state information is output to the communication quality prediction unit 1-8 through communication, and when the surrounding environment information collection unit 1-2 and the object determination unit 1-4 are included in both the external network unit 0 and the communication terminal 1, the object state information can be collected from the object determination units included in the communication terminal 1 and the external NW, and the object information from both the external network unit 0 and the communication terminal 1 can be used for learning and prediction. Further, the communication terminal 1 may introduce, via the external network unit 0, a communication quality model created from the object state information, the communication device state information, and the communication quality acquired by the other communication terminal.

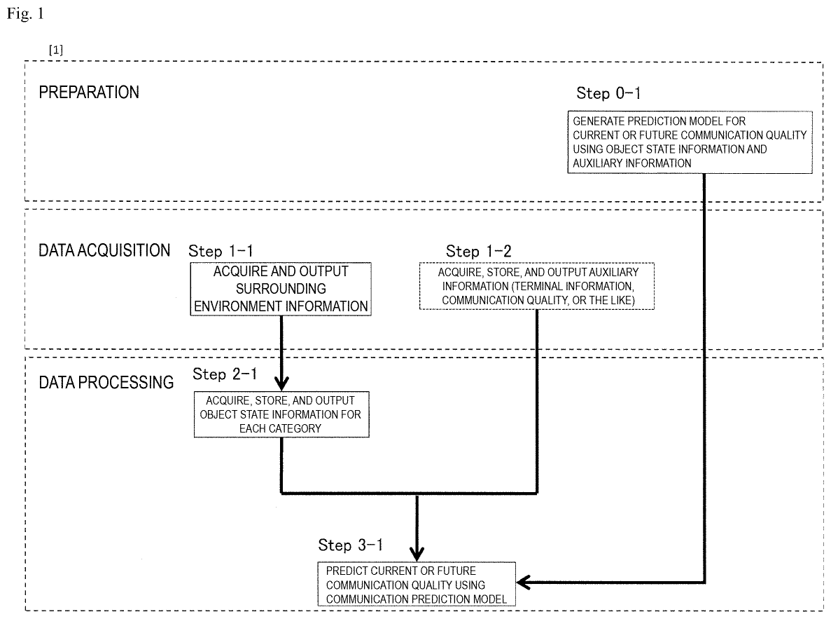

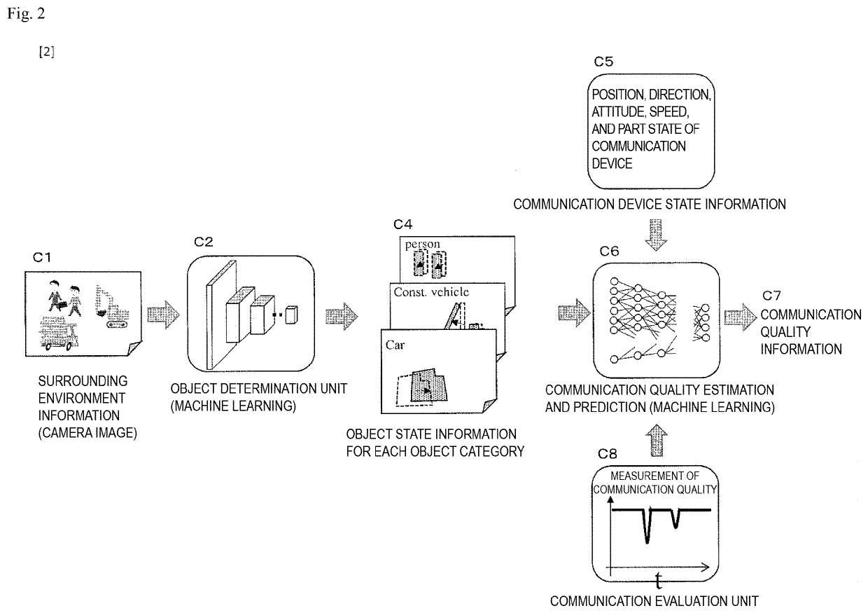

FIGS. 1 and 2 are diagrams illustrating a method of predicting communication quality performed by the present communication system. The prediction method includes three steps: “preparation,” “data acquisition,” and “data processing.”

C1 of FIG. 2 and step 1-1 in FIG. 1 are a step of acquiring the surrounding environment information from the surrounding environment information unit 1-2 (a sensor, a camera, or the like) installed in one or both of the communication devices. Here, the surrounding environment information also includes sampling intervals of the sensor or the camera.

In C2 of FIG. 2 and step 2-1 of FIG. 1, the object determination unit 1-4 acquires, for each category, object state information such as a class, position information, speed information, and state information of an object existing as a recognized object from the surrounding environment information obtained in C1 of FIG. 2. Here, the position information is, for example, a center position, width, height, contour, distance, and depth of the object in an angle of view or in the real world. The speed information is, for example, an amount of change in position in the angle of view or in the real world. The state information is, for example, a shape, weight, direction, and temperature of the object.

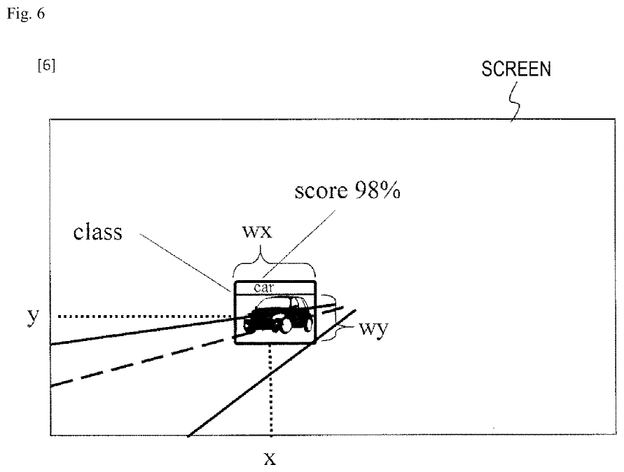

FIG. 6 is a diagram illustrating an example of the object determination unit 1-4. The object determination unit 1-4 can output a class, score, position, and size of the object for each frame from the image acquired from the camera. The object determination unit 1-4 uses, for example, an object recognition technology YOLOv3 (see, for example, NPL 2). The object determination unit 1-4 outputs position coordinates (x, y), a width wx, a height wy, a belonging class, and an object score of the recognized object on a screen as the object state information, as illustrated in FIG. 6. The object score is a value indicating reliability that an object belongs to its class.

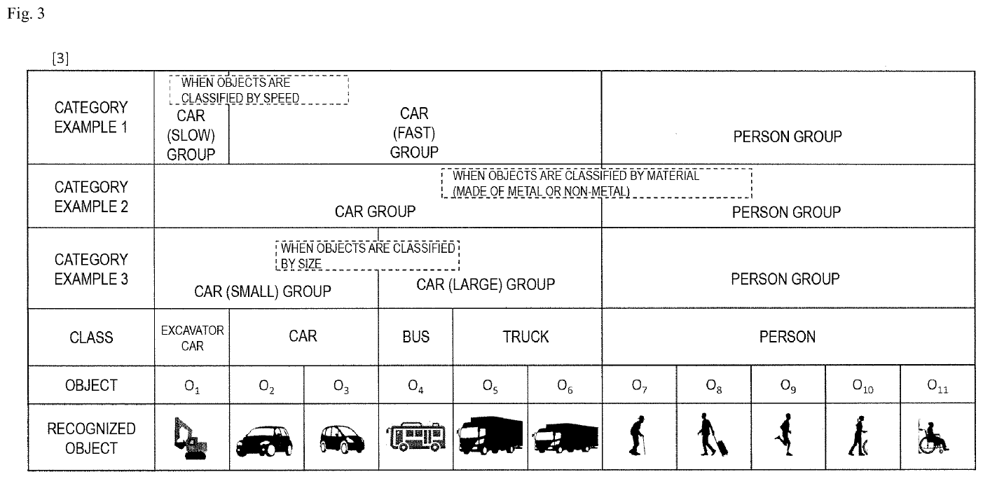

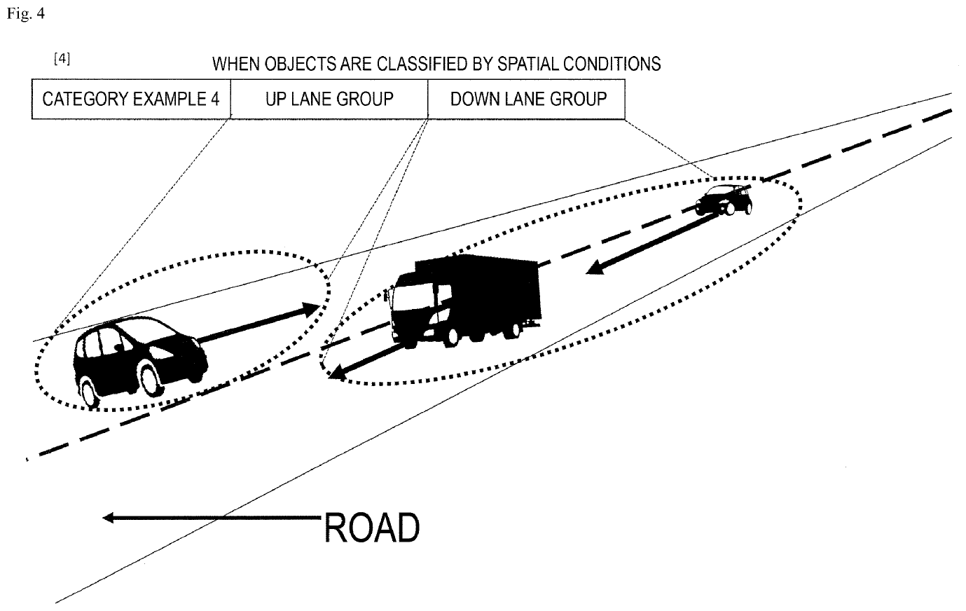

Here, the category is determined based on the similarity of a degree of influence of an object belonging to a certain class on radio wave propagation in a frequency band used in wireless communication. This similarity depends on a material, size, operation, recognized position, or the like of the object. An influence of the object belonging to the class on the communication quality is investigated in advance, and a category corresponding to each class is determined and set in the category definition unit 1-3. FIGS. 3 and 4 illustrate category setting examples. Category setting example 1 in FIG. 3 is an example in which objects are classified by speed. Category setting example 2 in FIG. 3 is an example in which objects are classified by material. Category setting example 3 in FIG. 3 is an example in which objects are classified by size. Category setting example 4 in FIG. 4 is an example in which objects are classified by spatial conditions (for example, up lanes and down lanes of a road).

When the object state information is acquired, past information obtained in C1 of FIG. 2 can also be used. A diagram in which cubes are arranged in C2 of FIG. 2 illustrates an image indicating a case in which deep learning such as CNN has been used when the object determination unit 1-4 acquires the object state information from the image. The object determination unit 1-4 may acquire the object state information by using other machine learning algorithms. Parameters in which machine learning is used have been learned in advance. C4 of FIG. 2 illustrates an example of the object state information for each category output from C3 of FIG. 2 (step 2-1 in FIG. 1).

In C5 of FIG. 2 and step 1-2 in FIG. 1, the communication device management unit 1-5 acquires communication device information such as a position, speed, and state of the communication terminal 1 or the other communication terminal. In C8 of FIG. 2 and step 1-2 in FIG. 1, the communication quality evaluation unit 1-6 evaluates the communication quality.

In C6 of FIG. 2 and step 3-1 in FIG. 1, the communication quality prediction unit 1-8 uses the communication quality model to predict the communication quality from the object state information. The communication quality prediction unit 1-8 may also use the communication device information at the time of prediction to perform the prediction. Further, the object determination unit may also use the information of C4 obtained by the object determination unit of the external NW or the other communication terminal to predict the communication quality. In this case, the information used for prediction may differ in each category. The communication quality is predicted by using some or all of past or current communication quality information. The communication quality model has been subjected to machine learning in advance (corresponding to step 0-1 in FIG. 1).

A diagram of C6 in FIG. 2 illustrates an image indicating a case in which the communication quality learning unit 1-7 generates a communication quality model using a neural network from the object state information (C4 of FIG. 2) and past or current communication quality (C8 of FIG. 2). The communication quality learning unit 1-7 may generate the communication quality model also using the communication state information (C5 of FIG. 2). The communication quality learning unit 1-7 is not limited thereto, and may generate the communication quality model using any method such as other machine learning or a statistical method.

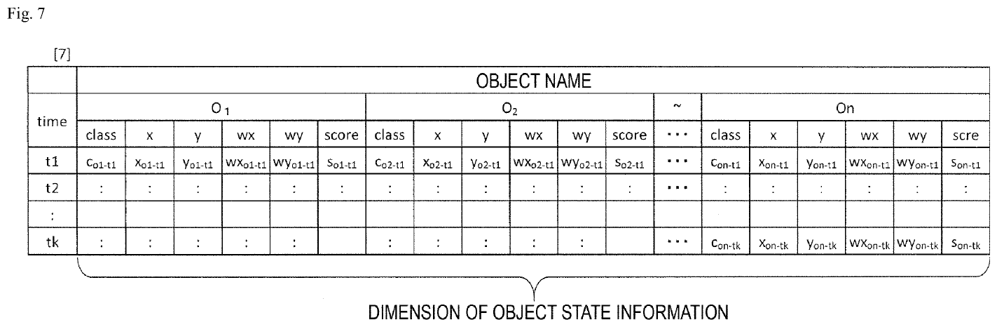

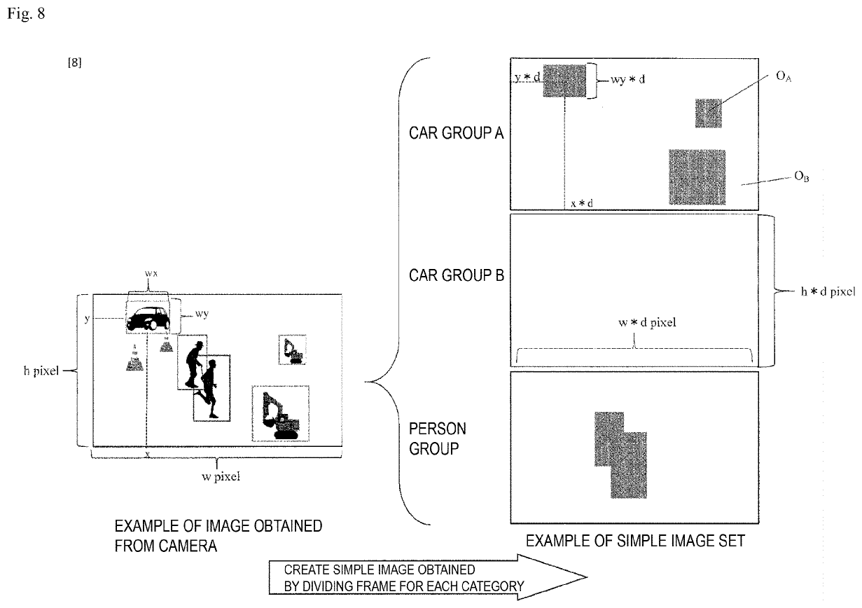

FIGS. 7 and 8 are diagrams illustrating a method of expressing the object state information. Because a dimension of data of the object state information changes according to classes or the number of objects recognized from the image, there is a problem in that calculation in the communication quality learning unit 1-7 or the communication quality prediction unit 1-8 becomes complicated. FIG. 7 illustrates an example of the acquired object state information. For each time t, five parameters of class, x, y, wx, wy, and score are obtained from respective objects O₁ to Oₙ. Because the number (n) of objects near the communication terminal 1 changes with time, the dimension of the object state information also changes with time.

In the present invention, frames are divided for each category and information is converted into a simple image so that a dimension of the object state information does not change regardless of the classes or number of recognized objects. FIG. 8 illustrates an example of the object state information in the present invention. An image for each category is created from the acquired image, so that dimensions can be made constant and data can be compressed. Further, the creation of the image for each category from the acquired image makes it possible to express the object state information at each time while considering characteristics of the influence of the object on the radio wave propagation.

FIG. 8 is a diagram illustrating an example in which simple images are created from the image obtained from the camera when three categories (car groups A and B and a person group) have been defined. It is assumed that the category to which each object belongs is pursuant to FIG. 3. From an image of h×w pixels, three images (a simple image set) corresponding to the respective categories of h/d×w/d pixels are created. d (0<d≤1) indicates a compression rate of the simple image. In the simple image, a range in which the object exists is filled with a score, speed, depth, and other predetermined values of the object, and a range in which the object exists is filled with “0”, so that the characteristics of the influence of the object on the radio wave propagation can also be expressed within the simple image.

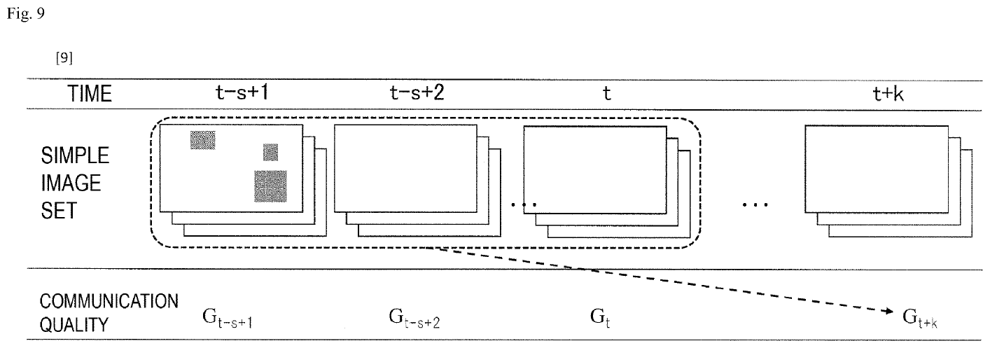

FIG. 9 is a diagram illustrating a method of predicting communication quality according to the object state information using a three-dimensional convolutional neural network (see, for example, NPL 3). FIG. 9 illustrates a case in which communication quality at t+k (after a time k) is predicted from simple image sets (simple images in a plurality of categories) for a time from t−s+1 to t. Here, s indicates a time width of image data that is input to the neural network. The simple image sets for the time from t−s+1 to t is input to the three-dimensional convolutional neural network, and a spatio-temporal feature is extracted. The communication quality is predicted from an obtained feature quantity by a fully connected neural network.

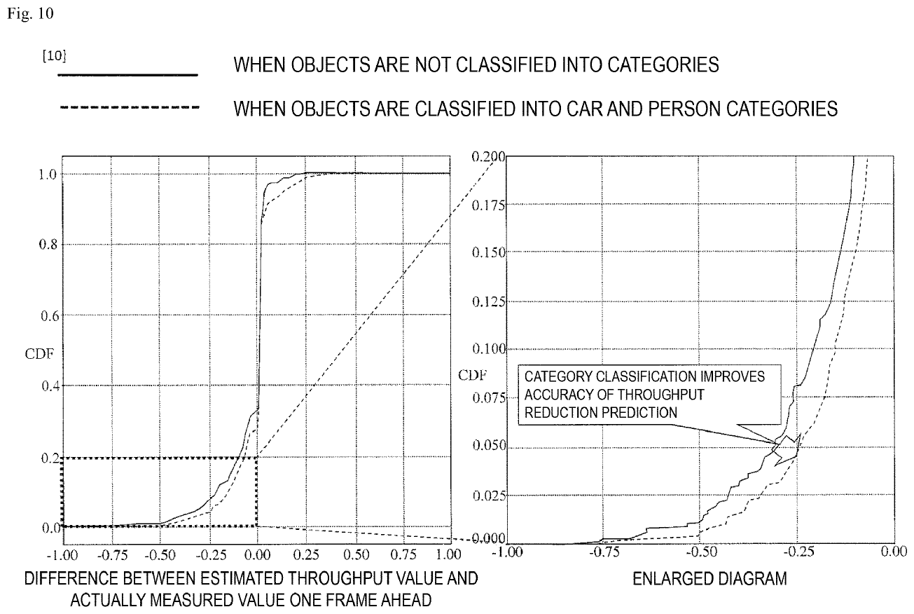

FIG. 10 is a diagram illustrating effects of the present communication system. In order to verify the effects, it is assumed that the present communication system is used for advance prediction of communication quality deterioration. In the communication quality prediction of the present communication system, a case in which objects are classified by category is compared with a case in which objects are not classified by category when the object state information is acquired from the same image. A horizontal axis of FIG. 10 indicates a result of subtracting predicted communication quality (throughput) from an actually measured value. When this value is negative, this means that the actually measured value is smaller than a predicted value. That is, this means that the deterioration of the communication quality cannot be sufficiently predicted, and actual deterioration of the communication quality has been larger than the predicted value. From a technical point of view, a case in which the actually measured value is smaller than the predicted value, that is, obtained difference information becomes negative, can be considered from the concept of positive and negative. When a communication quality deterioration event is defined as positive, a negative result of subtraction of the predicted value from the actually measured value corresponds to a false negative in which the event is determined to be negative even though the event is actually positive. As a learning and predicting method in machine learning of an actual system, modeling can be performed so that true positives and true negartives are maximized, and learning may be performed so that a probability of a false positive or false negative is minimized with true positives or true negartives increased. Further, a case is also considered in which, in this verification, a false negative is not acceptable but a false positive is acceptable. Considering this in the prediction of communication quality deterioration, although the communication quality deterioration is desired to be reliably predicted, a case in which communication quality deterioration has been predicted but the communication quality does not actually deteriorate (false positive) is ascertained as an acceptable case. In FIG. 10, the left side of 0 at a center of the horizontal axis means that the predicted value is greater than the actually measured value (false negative), and the right side means that the predicted value is smaller than the actually measured value (false positive). Thus, when the present communication system is used to predict communication quality deterioration, it is preferable for a negative distribution in FIG. 10 to be as close to 0 as possible.

A vertical axis of FIG. 10 indicates prediction accuracy (a cumulative distribution function). A solid line indicates a result when objects are not classified by category, and a dotted line indicates a result when the objects are classified into the two categories of vehicle and pedestrian. It can be seen that a difference is closer to 0, 100% is reached, and the prediction accuracy is higher when the objects are classified by category than when the objects are not classified by category.

### Variation of Embodiments

When the communication terminal 1 is a base station that predicts communication quality of a downlink or an uplink, the communication device management unit 1-5 acquires information such as a position of a mobile terminal, which is another communication terminal, via the communication unit (1-1-1 to 1-1-N) and generates communication device state information.

When the communication terminal 1 is a mobile terminal that predicts communication quality of a downlink or an uplink, the communication device management unit 1-5 generates communication device state information from, for example, a position of its own communication device. Further, information such as a position of a base station serving as a communication partner or antenna conditions may be collected via the communication units (1-1-1 to 1-1-N), and the communication device management unit 1-5 may generate the communication device state information.

When the communication terminal 1 is a base station that predicts communication quality of a sidelink, the communication device management unit 1-5 acquires, for example, position information of a mobile terminal, which is another communication terminal, via the communication units (1-1-1 to 1-1-N), and generates communication device state information including position information of its own communication device.

In a wireless communication system, a wireless LAN as defined by IEEE802.11, Wigig (trade name), IEEE802.11p, a communication standard for ITS, cellular communication such as LTE or 5G, wireless communication such as low power wide area (LPWA), or communication using sound waves, electricity, and light can be used.

Supplements

The following is a description of the communication system of the present embodiment.

### Object

An object of the present invention is to provide a communication system and a terminal capable of predicting future communication quality to be able to cope with a change in communication quality due to an environmental change.

### Solution to Problem

Surrounding environment information on surroundings of a communication device is collected from cameras, sensors, broadcast information collection devices, and other surrounding environment information collection devices.

Surrounding objects are determined from the surrounding environment information, and the object state information such as a position, shape, size, motion, velocity, and acceleration of each object is acquired for each category.

In the object categories, the objects are classified into groups based on similarity of influence on communication quality, and the object categories can be defined by materials having a large influence on the radio wave propagation, positions in which the objects are present, and conditions of the motion.

A relationship between a feature quantity for communication prediction and the communication quality is modeled by machine learning. The feature quantity for communication prediction includes at least object state information for each category and is defined inclusive of communication device state information such as a position, direction, motion, velocity, and acceleration of an own communication device or a partner that performs communication, or both, or past communication quality information.

### Effects of the Invention

According to the present invention, the object state information is collected for each category having a similar influence on the communication quality from the surrounding environment information obtained by the surrounding environment information collection device, making it possible to efficiently learn the relationship between the feature quantity for communication prediction and the communication quality, to reduce a required amount of data used for learning, and to predict communication quality of wireless communication used by a terminal with high accuracy.

### REFERENCE SIGNS LIST

0: External network unit
1: Communication device
1-0: Network in device
1-1-1 to 1-1-N: Communication unit
1-2: Surrounding environment information collection unit
1-3: Category definition unit
1-4: Object determination unit
1-5: Communication device management unit
1-6: Communication quality evaluation unit
1-7: Communication quality learning unit
1-8: Communication quality prediction unit

1. A communication terminal for performing wireless communication, the communication terminal comprising:
a surrounding environment information collection unit configured to photograph surroundings of the communication terminal at time intervals to generate surrounding environment information;
an object determination unit configured to determine recognized objects included in the surrounding environment information on a category-to-category basis to generate object state information; and
a communication quality prediction unit configured to estimate current or future communication quality from the object state information including current object state information using a communication quality model generated by performing, in advance, machine learning of a relationship between communication quality information obtained by evaluating communication quality of the wireless communication at time intervals and the object state information of all the categories.

2. The communication terminal according to claim 1, further comprising:
a communication device management unit configured to measure a current position of the communication terminal, a position of a communication terminal serving as a communication partner, or positions, attitudes, motions, and other states of the communication terminal and the communication terminal serving as the communication partner to generate communication device state information, wherein
the communication quality prediction unit estimates the communication quality based also on the communication device state information, using the communication quality model generated by performing machine learning based also on the communication device state information.

3. The communication terminal according to claim 1, further comprising:
a communication quality evaluation unit configured to evaluate the communication quality of the wireless communication and generate the communication quality information together with corresponding time information, and
a prediction model generation unit configured to perform machine learning of the relationship between the object state information corresponding to the categories and the communication quality information to generate the communication quality model, wherein
the surrounding environment information collection unit photographs the surroundings of the communication terminal to generate the surrounding environment information together with corresponding time information.

4. The communication terminal according to claim 3, wherein
the communication device management unit generates the communication device state information including time information corresponding to measurement, and
the prediction model generation unit performs machine learning based also on the communication device state information to generate the communication quality model.

5. The communication terminal according to claim 1, wherein
the object determination unit fills a position corresponding to each recognized object in the object state information within an image captured by the surrounding environment information collection unit with a predetermined value, and fills other positions with “0.”

6. The communication terminal according to claim 5, wherein
the object determination unit determines the position within the image by using position and size information of the recognized object in the object state information.

7. The communication terminal according to claim 5, wherein
the object determination unit uses a value of a speed, object score, or depth of the recognized object as the predetermined value.

8. A communication quality prediction method comprising:
photographing surroundings of a communication terminal configured to perform wireless communication at time intervals to generate surrounding environment information;
determining recognized objects included in the surrounding environment information on a category-to-category basis to generate object state information; and
estimating current or future communication quality from the object state information including current object state information using a communication quality model generated by performing, in advance, machine learning of a relationship between communication quality information obtained by evaluating communication quality of the wireless communication at time intervals and the object state information of all the categories.

9. The communication quality prediction method according to claim 8, further comprising:
determining the categories based on an operation or material of the object, and
replacing the previous categories with the determined categories.
